(19) United States
(12) Patent Application Publication
(10) Pub. No.: US 2013/0064748 A1
(43) Pub. Date: Mar. 14, 2013

(54) METHOD AND APPARATUS FOR CAPTURING SOx IN A FLUE GAS PROCESSING SYSTEM

(71) Applicants: SANJAY K. DUBE, KNOXVILLE, TN (US); MICHAEL G. VARNER, KNOXVILLE, TN (US); DAVID J. MURASKIN, KNOXVILLE, TN (US)

(72) Inventors: SANJAY K. DUBE, KNOXVILLE, TN (US); MICHAEL G. VARNER, KNOXVILLE, TN (US); DAVID J. MURASKIN, KNOXVILLE, TN (US)

(73) Assignee: ALSTOM TECHNOLOGY LTD, Baden (CH)

(21) Appl. No.: 13/417,350

(22) Filed: Mar. 12, 2012

Related U.S. Application Data
(60) Provisional application No. 61/481,406, filed on May 2, 2011.

(51) Int. Cl. B01D 53/50; F01N 3/08

(52) U.S. Cl. 423/243.08; 422/173

(57) ABSTRACT

Systems and processes for treating a flue gas for removing sulfur oxides (SOx) entrained in the flue gas generally includes contacting the gas stream with an aqueous alkali and/or alkaline earth metal hydroxide solution such as sodium hydroxide and reacting SOx entrained in the gas stream to form an aqueous alkali and/or alkaline earth metal sulfur-containing salt solution such as sodium sulfate. The aqueous alkali and/or alkaline earth metal sulfur-containing salt solution can be introduced into an electrodialysis apparatus configured to electrolyze water to form hydrogen and hydroxyl ions that selectively combine with alkali and/or alkaline earth metal ions and sulfur containing ions from the aqueous alkali and/or alkaline earth metal sulfur containing salt feedstream to form a regenerated alkali and/or alkaline earth metal hydroxide feedstream and an acid containing feedstream.

### CROSS REFERENCE TO RELATED APPLICATIONS

The present application claims the benefit of U.S. Provisional Application No. 61/481,406 filed on May 2, 2011, incorporated herein by reference in its entirety.

### BACKGROUND

The present disclosure generally relates to systems and processes for CO₂ capture entrained in flue gases. More particularly, the present disclosure relates to sulfur removal in a flue gas processing system, which is often in the form of sulfur oxides, commonly referred to as “SOx”.

Most of the energy used in the world is derived from the combustion of carbon and hydrogen-containing fuels such as coal, oil and natural gas. In addition to carbon and hydrogen, these fuels contain, among others, undesirable contaminants such as SOx, e.g., SO₂, SO₃ and the like. Awareness regarding the damaging effects of the contaminants released during combustion triggers the enforcement of ever more stringent limits on emissions from power plants, refineries and other industrial processes. There is an increased pressure on operators of such plants to achieve near zero emission of contaminants.

Numerous processes and systems have been developed in response to the desire to achieve near zero emission of contaminants. Systems and processes include, but are not limited to desulfurization systems (known as wet flue gas desulfurization systems (“WFGD”) and dry flue gas desulfurization systems (“DFGD”)), particulate filters (including, for example, bag houses, particulate collectors, and the like), as well as the use of one or more sorbents that absorb contaminants from the flue gas. Examples of sorbents include, but are not limited to, activated carbon, ammonia, limestone, and the like. However, desulfurization systems are not 100% efficient.

It has been shown that ammonia, as well as amine solutions, efficiently removes CO₂, as well as other contaminants, such as sulfur dioxide (SO₂) and hydrogen chloride (HCl), from a flue gas stream. In one particular application, CO₂ is absorbed in an ammoniated solution at temperatures lower than the exit temperature from the flue gas desulfurization system, for example, between 0 and 30° C. The SOx contaminants, e.g., SO₂, SO₃, remaining in the flue gas coming from the wet flue gas desulfurization (WFDS) and/or dry flue gas desulfurization (DFGD) is often captured by ammonia to produce an ammonium sulfate bleed stream at a temperature of about 50-60° C. Capturing SOx at these temperatures and at high pH can result in the release of ammonia into the flue gas, which can contaminate downstream circulating water. For example, at certain concentrations, a pH value greater than 5 may result in ammonia levels in the vapor phase that are higher than desired values which can contaminate condensed water in the downstream stages of the column. Once contaminated, disposal of the water stream may be difficult. Also, the processing of the ammonia sulfate byproduct bleed stream can be energy and capital cost intensive. In some cases, the use of crystallization, evaporation, agglomeration equipment is needed in order to produce a fertilizer product for commercial use. In addition, a large area for silos\bins for indoor storage of the ammonium sulfate byproduct may be needed on-site to insure plant availability. In addition, trace metals may be present in the ammonium sulfate stream that may require further treatment or disposal of the ammonium sulfate stream as a hazardous waste. For example, for CO₂ capture systems which use amine solutions, sulfur compounds present in the flue gas will react with the amine reagent and render it useless. The sulfonated amine must then be discarded and replenished with fresh reagent. The result is higher operating costs and capital costs because of the larger equipment needed to account for sulfur and the higher reagent make-up rates.

Accordingly, there is a need in the art for improved processes and apparatuses for capturing SOx in the flue gas before the flue gas stream reaches the CO₂ capture plant and subsequent treatment of the bleed stream.

### BRIEF SUMMARY

Disclosed herein are processes for removing water soluble contaminants such as SOx from a gas stream and a gas purification system. In one embodiment, the process comprises contacting the gas stream with an aqueous alkali and/or alkaline earth metal hydroxide solution and reacting SOx entrained in the gas stream to form an aqueous alkali and/or alkaline earth metal sulfur-containing salt solution.

In another embodiment, the process of removing SOx from a gas stream comprises simultaneously lowering a temperature of the gas stream with an aqueous alkali and/or alkaline earth metal hydroxide solution and reacting SOx entrained therein to form an aqueous alkali and/or alkaline earth metal sulfur-containing salt solution; electrolyzing water in an electrodialysis reactor to form hydrogen and hydroxyl ions; and introducing the aqueous alkali and/or alkaline earth metal sulfur-containing salt solution into the electrodialysis reactor and selectively combining alkali and/or alkaline earth metal ions with the hydroxyl ions to form a regenerated alkali and/or alkaline earth metal hydroxide feedstream and selectively combining sulfur containing ions with the hydrogen ions to form an acid feedstream.

The gas purification system for removal of gaseous acidic components and water soluble contaminants from a gas stream comprises a direct contact cooler in fluid communication with a flue gas, wherein the direct contact cooler comprises a recirculation loop configured to cool the flue gas with an aqueous alkali and/or alkaline earth hydroxide solution flowing countercurrent to the flue gas, wherein the aqueous alkali and/or alkaline earth hydroxide solution reacts with SOx contained in the flue gas to form an aqueous alkali and/or alkaline earth metal sulfur containing salt feedstream; and an electrolytic apparatus in fluid communication with the direct contact cooler to receive the aqueous alkali and/or alkaline earth metal sulfur containing salt feedstream, wherein the electrolytic apparatus is configured to electrolytically generate hydrogen and hydroxyl ions that selectively combine with alkali and/or alkaline earth metal ions and sulfur containing ions from the aqueous alkali and/or alkaline earth metal sulfur containing salt feedstream to form a regenerated alkali and/or alkaline earth metal hydroxide feedstream and an acid containing feedstream.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 is a partial schematic representation of a flue gas stream processing system utilized to remove SOx contaminants from the flue gas stream;

FIG. 2 is a schematic cross sectional representation of a bipolar membrane electrodialysis unit; and

FIG. 3 is a schematic illustration of an exemplary direct contact cooling tower.

### DETAILED DESCRIPTION

Disclosed herein are systems and processes for overcoming the problems with the use of ammonia as it relates to removal of contaminants from the flue gas such as SOx in prior art systems and processes. The system and process generally includes replacing the ammonia reagent circulating in a direct contact cooler (DCC),or separate unit operations step, with an alkali and/or alkaline earth metal hydroxide reagent such as sodium hydroxide so as to more efficiently remove SOx from the flue gas as the flue gas is cooled. Advantageously, since the alkali and/or alkaline earth metal hydroxides generally have a lower vapor pressure than ammonia, the use of the alkali and/or alkaline earth metal hydroxides solves the contamination issues mentioned above of the downstream unit operations. While reference will be made to chilled ammonia processes (CAP) and apparatuses, the present invention can also be utilized in advanced amine and oxy-fuel processes and apparatuses configured as such.

In the CAP, CO₂ is absorbed in an ammoniated or amine solution at temperatures lower than the exit temperature from the flue gas desulfurization system. As such, it is necessary to cool the flue gas prior to CO₂ absorption. The DCC and an optional chiller provide the necessary cooling of the flue gas prior to carbon dioxide absorption in an absorption unit. The DCC is also used to remove water by condensation from the incoming flue gas. In the present invention, an alkali and/or alkaline earth metal hydroxide reagent is introduced into the DCC and reacts with any SOx (e.g., SO₂, SO₃) entrained in the flue gas to form an aqueous alkali and/or alkaline earth metal sulfur salt solution. For example, if the flue gas includes SO₂ and SO₃ and the ammonia reagent is replaced with sodium hydroxide, the resulting reaction provides an aqueous sodium sulfite and/or sodium sulfate solution. As will be discussed in greater detail below, the system is closed looped and includes an electrodialysis unit in fluid communication with the DCC for electrolytically regenerating the alkali and/or alkaline earth metal hydroxide from the aqueous alkali and/or alkaline earth metal sulfur containing salt solution. The electrodialysis unit is configured to dissociate the aqueous alkali and/or alkaline earth metal sulfur salt solution into the corresponding acidic and basic ionic species using an electrical driving force. A suitable electrodialysis unit is a bipolar membrane electrodialysis unit.

Bipolar membranes generally include an anion exchange membrane and a cation exchange membrane physically or chemically bonded together. Under a driving force of an electrical field, the bipolar membrane dissociates water into hydrogen and hydroxyl ions. There are substantial advantages to water splitting with the bipolar membrane. Since there are no gases evolved at the surface or within the bipolar membranes, the energy associated with conversion of O₂ and H₂ is saved. Moreover, as will be discussed in greater detail below, the ions generated in the electro dialysis unit pass though anion and cation exchange permselective membranes to react with the aqueous alkali and/or alkaline earth metal sulfur salt solution to produce the corresponding acid (e.g., sulfuric acid, sulfurous acid) and regenerated alkali and/or alkaline earth metal hydroxide feed streams. The acid containing feedstream can then be circulated to the wet flue gas desulfurization unit (WFGD) where it reacts with an alkali and/or alkaline earth therein whereas the regenerated alkali and/or alkaline earth metal hydroxide feedstream can be recycled to the DCC to treat additional flue gas and react with the SOx entrained therein. By recycling the alkali and/or alkaline earth metal hydroxide in this manner, the system eliminates the need for an external alkali and/or alkaline earth metal hydroxide source, and therefore, advantageously reduces the operating cost of CAP significantly. Additionally, the present invention eliminates the need for the end user to handle the byproduct stream that would typically be generated using an ammonia solution (i.e., the ammonium sulfate), which will further enhance the efficiency of the CAP. Moreover, because of the relatively low vapor pressure associated with alkali and/or alkaline earth metal hydroxides, downstream water contamination with ammonia is substantially eliminated.

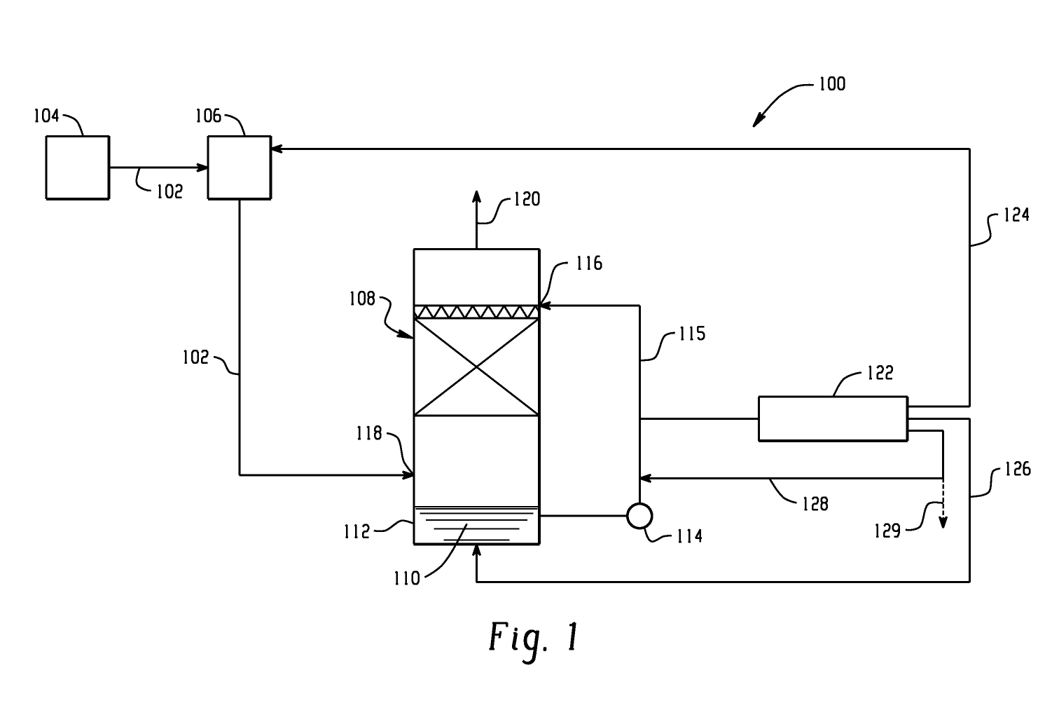

Turning now to FIG. 1, there is shown a partial schematic representation of a flue gas stream processing system, generally designated by reference numeral 100, configured to effectively remove SOx from a flue gas during cooling and avoid the problems associated with ammoniated systems. A flue gas stream 102 is first generated by combustion of a fuel such as combustion of coal in a furnace 104, for example. The flue gas stream 102 may optionally be treated in a flue gas desulfurization unit 106 such as a dry or wet flue gas desulfurization unit. The flue gas exiting the flue gas desulfurization unit is typically at a temperature of about 50-60° C. for WFGD systems and about 80-100° C. for DFGD systems. The gas is water saturated for systems that employ WFGD whereas for systems with upstream DFGD, the gas has temperature that is approximately 20 to 40° F. above moisture saturation and each gas stream typically contains residual contaminants including SOx, among others. In order to cool the saturated gas, both sensible heat and latent heat for water vapor condensation has to be removed. To accomplish this, the flue gas is fed to a direct contact cooling tower vessel (DCC) 108 to reduce the temperature of the flue gas and to further remove contaminants such as SOx.

The direct contact cooler 108 may be a packed tower with liquid recirculation through a cooling tower having multiple stages that uses ambient air to lower the recirculation liquid temperature. An alkali and/or alkaline earth metal hydroxide reagent such as sodium hydroxide is introduced into a first stage of the DCC as shown and mixed with the cooling water 110 at a bottom portion 112 of the DCC. The aqueous alkali and/or alkaline earth metal hydroxide solution 110 is pumped via pump 114 through a conduit 115 to a top portion 116 of the DCC. Optionally, the aqueous alkali and/or alkaline earth metal hydroxide solution may first be pumped to a chiller (not shown) to further lower the temperature of the aqueous alkali and/or alkaline earth metal hydroxide solution. Flue gas enters the DCC inlet 118 at the bottom portion 112 and flows upward through the packing. Cool aqueous alkali and/or alkaline earth metal hydroxide solution is sprayed at the top of the packing and flows downwards, counter to the flue gas flow 120. As the flue gas flows upwards through DCC, the flue gas is forced into contact with the aqueous alkali and/or alkaline earth metal hydroxide solution. Direct cooling of the saturated flue gas in subsequent stages results in the condensation of most of the water in the flue gas stream. In addition to reaction of SOx, the residual gases present in the flue gas are generally rendered water soluble. Moreover, any SOx contaminants entrained in the flue gas react with the aqueous alkali and/or alkaline earth metal hydroxide solution to form a feedstream of the corresponding aqueous alkali and/or alkaline earth metal sulfur containing salt solution.

An electrodialysis unit 122 is in fluid communication with a conduit e.g., 115, to receive the aqueous alkali and/or alkaline earth metal sulfur containing salt solution feedstream. Under the driving force of an electric field, the electrodialysis unit 122 produces three feed streams: an acid feed stream is generated that can be fed to the flue gas desulfurization unit 106 via conduit 124, a regenerated alkali and/or alkaline earth metal hydroxide feed stream is generated that can be recycled back to the DCC via conduit 126; and a water feed stream is generated and recycled back to the DCC via conduit 128. Optionally, water is purged from the system, as shown by dotted line arrow 129, depending on the process needs.

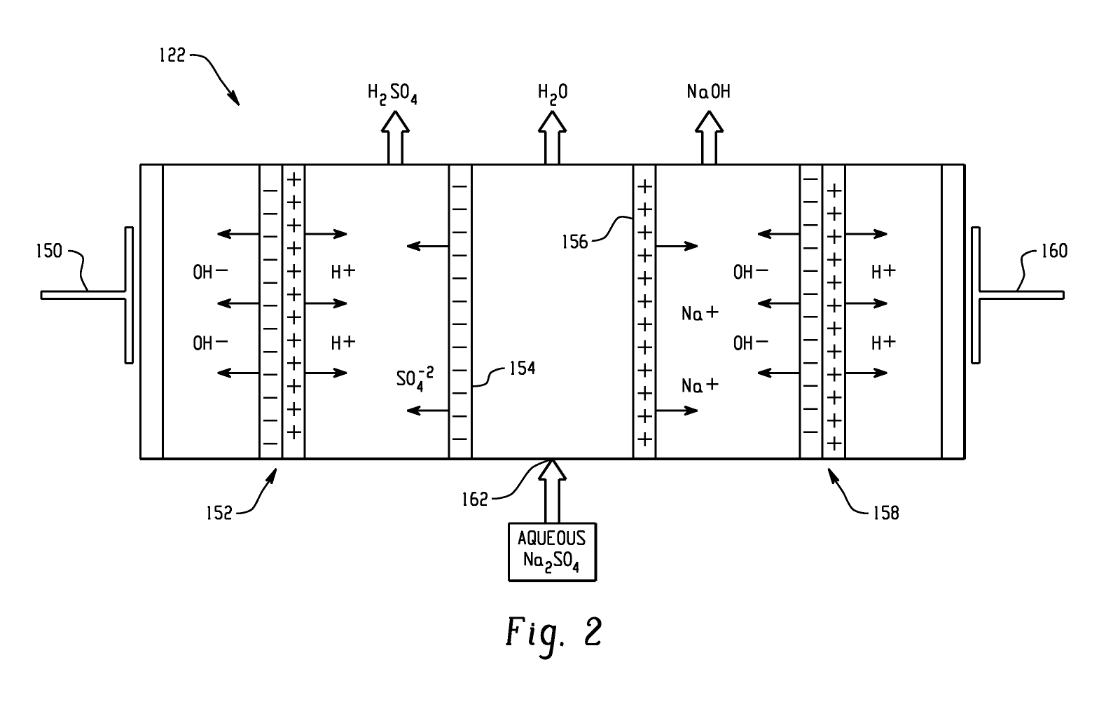

As shown more clearly in FIG. 2, the exemplary electrodialysis unit 122 includes an anode 150, a bipolar membrane 152, an anion exchange permselective membrane 154, a cation exchange permselective membrane 156, bipolar membrane 158 and a cathode 160, and wherein the anode 150 and cathode 160 are in electrical communication with a source of direct current (not shown). An inlet 162 introduces the aqueous alkali and/or alkaline earth metal sulfur containing salt solution feedstream into the electrodialysis unit 122, wherein the permselective cation and anion exchange membranes separate the alkali and/or alkaline earth metal and sulfur containing ions. The alkali and/or alkaline earth metal cations are transported across the cation permselective membrane whereas the sulfur containing anions are transported across the anion permselective membrane. For ease of understanding, the sulfur containing anions are shown as sulfate anions in FIG. 2, but for reasons discussed above are not intended to be limited as such. Other sulfur containing anions including mixtures thereof may be generated depending on the SOx present in the flue gas.

Under the driving force of an electrical field, the bipolar membranes 152, 158 dissociate water into hydrogen (H⁺) and hydroxyl (OH⁻) ions. The bipolar membranes are formed of an anion- and a cation-exchange layer that are bound together, either physically or chemically, and a very thin interface where the water diffuses from the aqueous sodium sulfur salt solution. The bipolar membranes 152, 158 are oriented such that the anion-exchange side faces the anode 150 and the cation-exchange side faces the cathode 160. The hydroxyl anions are transported across the anion-exchange layer and the hydrogen cations across the cation-exchange layer of the bipolar membrane. These ions are used in the electro dialysis stack to selectively combine with the alkali and/or alkaline earth metal cations (e.g., Na⁺) and sulfur containing anions (e.g., sulfate ions (SO₄²⁻), sulfite anions (SO₃²⁻) and the like) from the aqueous sodium sulfur containing salt solution to produce an acid effluent such as sulfuric acid (H₂SO₄), sulfurous acid (H₂SO₃) and a alkali and/or alkaline earth metal hydroxide (e.g., NaOH) effluent. Other acid gases such as hydrogen chloride (HCl) and hydrogen fluoride (HF) present in the incoming flue gas will also be absorbed into the DCC solution and dissociate in the liquid. The resulting cations and anions may combine with other dissolved anions and cations in the DCC solution to form salts.

As used herein, the term “membrane” generally refers to a sheet for separating adjacent compartments. In this regard, the term “membrane” can be used interchangeably with screen, diaphragm, partition, barrier, a sheet, a foam, a sponge-like structure, a canvas, and the like. The membrane is chosen to be permselective, e.g., a cation exchange membrane, bipolar membrane, or anion membrane. As used herein, the term “permselective” refers to a selective permeation of commonly charged ionic species through the membrane with respect to other diffusing or migrating ionic species having a different charge in a mixture. For example, in a permselective membrane such as a cation exchange membrane, cations can freely pass through the membrane whereas the passage of anions is prevented.

The anode 150 and the cathode 160 may be made of any suitable material based primarily on the intended use of the electrolytic reactor, costs and chemical stability. For example, the anode 150 may be made of a conductive material, such as ruthenium, iridium, titanium, platinum, vanadium, tungsten, tantalum, oxides of at least one of the foregoing, combinations including at least one of the foregoing, and the like. The cathode 160 may be made from stainless steel, steel or may be made from the same material as the anode 150.

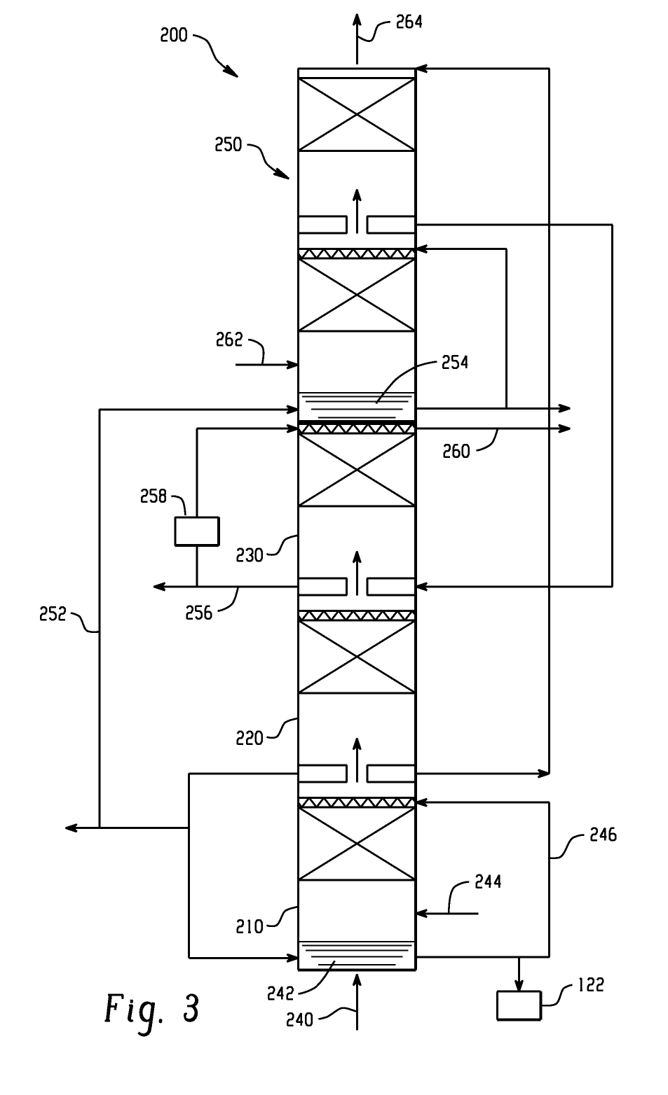

As shown more clearly in FIG. 3, an exemplary DCC 200 is illustrated including multiple stages 210, 220, and 230. Although two additional stages are shown, the number of stages is not intended to be limited and may include more or less stages depending on the desired use. The alkali and/or alkaline earth metal hydroxide 240 is introduced to the cooling water 242 of the first stage 210. The alkali and/or alkaline earth metal hydroxide containing cooling water circulates via conduit 246 to a top portion of the first stage 210. A flue gas stream 244 enters the first stage via inlet 244 and flows counter to flow of the alkali and/or alkaline earth metal hydroxide containing cooling water. As the flue gas flows upward, the alkali and/or alkaline earth metal hydroxide containing cooling water contacts the flue gas and reacts with SOx contaminants to form the corresponding sulfur containing salt, which can then be fed to the electrodialysis unit 122 for further processing as discussed in relation to FIG. 1. The acid feedstream generated by the electrodialysis unit 122 can be fed to a flue gas desulfurization unit 250 via line 252. In particular, the acid feedstream may be introduced to the cooling water 254 of the desulfurization unit 250. The desulfurization unit 250 may include one or more stages depending on the design.

The subsequent stages of the DCC, e.g., 230, 240 can be configured to cool the flue gas. In this manner, a portion of the cooling water may be introduced via line 256 to a chiller 258 to reduce the temperature of the flue gas. Condensation water resulting from chilling may be discharge as needed. The flue gas may then be fed via line 260 directly to an absorption unit (not shown) for removal of CO₂ entrained therein as well as removal of any additional contaminants.

The absorption unit typically includes a CO₂ absorption section and a water wash section. In some systems, these sections are a packed bed column. In the CO₂ absorption section, the flue gas is contacted with a first wash liquid comprising ammonia and/or an amine compound, e.g., by bubbling the flue gas through the first wash liquid or by spraying the first wash liquid into the flue gas. Exemplary amine compounds include, without limitation, monoethanolamine (MEA), diethanolamine (DEA), methyldiethanolamine (MDEA), diisopropylamine (DIPA), and aminoethoxyethanol (diglycolamine), and combinations thereof. The amine based wash solution may further include a promoter and/or an inhibitor. The promoters are generally utilized to enhance the reaction kinetics involved in the capture of CO₂. Exemplary promoters include an amine such as piperazine or enzymes such as carbonic anhydrase or its analogs. The promoters may be in the form of a solution or immobilized on solid or semisolid surfaces. Inhibitors are generally provided to minimize corrosion and solvent degradation. In the CO₂ absorption section, CO₂ from the flue gas is absorbed in the first wash liquid.

The flue gas depleted of CO₂ then enters the water wash section of the absorption unit, wherein the water wash section is arranged to allow contact between the flue gas and a second wash liquid, which is generally water. The flue gas from the wash water may be introduced via line 262 to the desulfurization unit 250 to neutralize any ammonia and/or amine contained therein. The flue gas may then be discharged to the stack via line 264.

The second wash liquid is fed to the absorption unit via line. In the water wash section, contaminants remaining in the flue gas when it leaves the CO₂ absorption section are absorbed. The contaminants can include the water soluble volatile degradation products such as ammonia, formaldehyde, degradation products of amine and the like. The flue gas, which is now depleted of CO₂ and contaminants, leaves the absorption unit and is typically discharged into the environment. Optionally, the treated flue gas depleted of CO₂ and contaminants may undergo further processing, e.g., particulate removal (not shown), solvent removal such as ammonia via acid treatment (not shown), reheat (not shown), and the like as would be appreciated by those skilled in the art prior to being released to the environment. The spent wash liquid (ammonia/amine and water) are recycled via a regenerator unit, wherein contaminants and CO₂ contained therein are thermally separated from the used wash liquid. The separated CO₂ leaving the regenerator 109 may be compressed.

Exemplary carbon capture systems including an absorption unit and a regeneration unit are disclosed in U.S. Pat. Nos. 7,846,240 and 7,862,788, incorporated herein by reference in their entireties.

Unless otherwise specified, all ranges disclosed herein are inclusive and combinable at the end points and all intermediate points therein. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A process for removal of gaseous contaminants from a gas stream, the process comprising:
contacting the gas stream with an aqueous alkali and/or alkaline earth metal hydroxide solution and reacting SOx entrained in the gas stream to form an aqueous alkali and/or alkaline earth metal sulfur-containing salt solution.

2. The process of claim 1, further comprising electrolytically regenerating the alkali and/or alkaline earth metal hydroxide solution from the aqueous alkali and/or alkaline earth metal sulfur-containing salt solution.

3. The process of claim 2, wherein electrolytically regenerating the alkali and/or alkaline earth metal hydroxide solution comprises introducing the aqueous alkali and/or alkaline earth metal sulfur containing salt solution to a bipolar membrane electrodialysis unit, wherein the bipolar membrane electrodialysis unit is configured to electrolyze water to form hydrogen and hydroxyl ions, wherein the hydrogen ions selectively combine with sulfur containing ions to form an acid feedstream and the hydroxyl ions selectively combine with alkali and/or alkaline earth metal ions to form the regenerated alkali and/or alkaline earth metal hydroxide feedstream.

4. The process of claim 3, further comprising feeding the acid feedstream to a flue gas desulfurization unit.

5. The process of claim 3, further comprising recirculating the regenerated alkali and/or alkaline earth metal hydroxide feedstream with the gas stream.

6. The process of claim 3, wherein the acid feedstream comprises sulfuric acid, sulfurous acid, or mixtures thereof.

7. The process of claim 3, wherein introducing the aqueous alkali and/or alkaline earth metal sulfur containing salt solution to the bipolar membrane electrodialysis unit selective exchanging sulfur containing anions through an anion permselective membrane to react with hydrogen ions to form the acid feedstream and selectively exchanging alkali and/or alkaline earth metal cations through a cation permselective membrane to react with the hydroxyl ions and form the regenerated alkali and/or alkaline earth metal hydroxide feedstream.

8. The process of claim 7, wherein water from the aqueous alkali and/or alkaline earth metal sulfur containing salt solution is discharged after selectively exchanging the sulfur containing anions and the alkali and/or alkaline earth metal cations from the bipolar membrane electrodialysis unit and returned to a direct contact cooler or purged from the system.

9. The process of claim 1, wherein the SOx is selected from the group consisting of SO₂ and SO₃.

10. The process of claim 1, wherein the alkali and/or alkaline earth metal hydroxide solution is a sodium hydroxide solution.

11. The process of claim 1, wherein contacting the gas stream with the aqueous alkali and/or alkaline earth metal hydroxide solution and reacting SOx entrained in the gas stream is at a first stage of a direct contact cooler.

12. A process of removing SOx from a gas stream, comprising
simultaneously lowering a temperature of the gas stream with an aqueous alkali and/or alkaline earth metal hydroxide solution and reacting SOx entrained therein to form an aqueous alkali and/or alkaline earth metal sulfur-containing salt solution;
electrolyzing water in an electrodialysis reactor to form hydrogen and hydroxyl ions; and
introducing the aqueous alkali and/or alkaline earth metal sulfur-containing salt solution into the electrodialysis reactor and selectively combining alkali and/or alkaline earth metal ions with the hydroxyl ions to form a regenerated alkali and/or alkaline earth metal hydroxide feedstream and selectively combining sulfur containing ions with the hydrogen ions to form an acid feedstream.

13. The process of claim 11, further comprising feeding the acid feedstream to a flue gas desulfurization unit.

14. The process of claim 11, wherein the gas stream is at a temperature of 50 to 60° C. and wherein contacting the gas stream with the aqueous alkali and/or alkaline earth metal hydroxide solution lowers the temperature of the gas stream to less than 50° C.

15. The process of claim 11, wherein the SOx is selected from the group consisting of SO₂ and SO₃.

16. The process of claim 11, wherein the aqueous alkali and/or alkaline earth metal hydroxide solution is a sodium hydroxide solution.

17. The process of claim 11, wherein the acid feedstream comprises sulfuric acid, sulfurous acid, or mixtures thereof.

18. A gas purification system for removal of gaseous acidic components and water soluble contaminants from a gas stream, comprising:
a direct contact cooler in fluid communication with a flue gas, wherein the direct contact cooler comprises a recirculation loop configured to cool the flue gas with an aqueous alkali and/or alkaline earth hydroxide solution flowing countercurrent to the flue gas, wherein the aqueous alkali and/or alkaline earth hydroxide solution reacts with SOx contained in the flue gas to form an aqueous alkali and/or alkaline earth metal sulfur containing salt feedstream; and
an electrolytic apparatus in fluid communication with the direct contact cooler to receive the aqueous alkali and/or alkaline earth metal sulfur containing salt feedstream, wherein the electrolytic apparatus is configured to electrolytically generate hydrogen and hydroxyl ions that selectively combine with alkali and/or alkaline earth metal ions and sulfur containing ions from the aqueous alkali and/or alkaline earth metal sulfur containing salt feedstream to form a regenerated alkali and/or alkaline earth metal hydroxide feedstream and an acid containing feedstream.

19. The gas purification system of claim 18, wherein the regenerated alkali and/or alkaline earth metal hydroxide feedstream is in a closed loop with the direct contact cooler.

20. The gas purification system of claim 18, wherein the acid feed stream is in fluid communication with a flue gas desulfurization unit.

21. The gas purification system of claim 18, wherein the electrolytic apparatus is a bipolar membrane electrodialysis apparatus.

22. The gas purification system of claim 18, the electrolytic apparatus comprises an anion permselective membrane for selectively exchanging the sulfur containing anions;
and a cation permselective membrane for selectively exchanging the alkali and/or alkaline earth metal cations from the aqueous alkali and/or alkaline earth metal sulfur containing solution and producing a water effluent feedstream.

23. The gas purification system of claim 18, wherein the water effluent from the electrolytic apparatus is in fluid communication with the direct contact cooler or is configured to be removed from the system.

24. The gas purification system of claim 18, wherein the direct contact cooler is a first stage direct contact cooler.
